(19) United States
(12) Patent Application Publication
(10) Pub. No.: US 2026/0332601 A1
(43) Pub. Date: Oct. 22, 2026

(54) ONTOLOGY-HIERARCHY-BASED METAVERSE NAVIGATION AND COLLABORATION

(71) Applicant: International Business Machines Corporation, Armonk, NY (US)

(72) Inventors: Michael BOONE, Lutz, FL (US); Jacob Ryan JEPPERSON, St. Paul, MN (US); Sarbajit Kumar RAKSHIT, Kolkata (IN); Carolina GARCIA DELGADO, Zapopan (MX)

(21) Appl. No.: 19/183,371

(22) Filed: Apr. 18, 2025

(51) Int. Cl. H04L 9/40; G06F 21/60

(52) U.S. Cl. CPC H04L 63/105; G06F 21/602; H04L 63/08

(57) ABSTRACT

In some implementations, a computer may obtain, for a domain, ontology hierarchy information that indicates a structure that includes multiple levels of classes. The computer may determine, based on the ontology hierarchy information, one or more navigational routes between multiple metaverse environments associated with the domain, wherein the multiple metaverse environments are associated with respective classes. The computer may determine, based on the ontology hierarchy information, one or more access control parameters for respective metaverse environments of the multiple metaverse environments. The computer may obtain contextual information for a metaverse collaborative session that is associated with a metaverse environment of the multiple metaverse environments. The computer may determine, for the metaverse environment, contextual access and navigational information based on the contextual information. The computer may manage, during the metaverse collaborative session, access and information to the metaverse environment based on the contextual access and navigational information.

### BACKGROUND

This disclosure relates to virtual worlds, and more specifically, to ontology-hierarchy-based metaverse navigation and collaboration.

### SUMMARY

Some aspects described herein relate to a method. The method may include obtaining, for a domain, ontology hierarchy information that indicates a structure that includes multiple levels of classes, where the ontology hierarchy information indicates one or more relationships among the multiple levels of classes. The method may include determining, based on the ontology hierarchy information, one or more navigational routes between multiple metaverse environments associated with the domain, where the multiple metaverse environments are associated with respective classes. The method may include determining, based on the ontology hierarchy information, one or more access control parameters for respective metaverse environments of the multiple metaverse environments, where the one or more access control parameters indicate one or more permissible users or permissible information types for the respective metaverse environments. The method may include obtaining contextual information for a metaverse collaborative session that is associated with a metaverse environment of the multiple metaverse environments. The method may include determining, for the metaverse environment, contextual access and navigational information based on the contextual information, where the contextual access and navigational information indicates at least one of one or more updated access control parameters, or one or more updated navigational routes. The method may include managing, during the metaverse collaborative session, access and information to the metaverse environment based on the contextual access and navigational information.

Some aspects described herein relate to a computer system. The computer system may include a processor set, one or more computer-readable storage media, and program instructions stored on the one or more computer-readable storage media to cause the processor set to perform operations. The operations may include obtaining, for a domain, ontology hierarchy information that indicates a structure that includes multiple levels of classes. The operations may include determining, based on the ontology hierarchy information, one or more navigational routes between multiple metaverse environments associated with the domain. The operations may include managing access to a first metaverse environment, of the multiple metaverse environments, based on a user role and the ontology hierarchy information. The operations may include updating the one or more navigational routes and access to the first metaverse environment based on one or more changes in the ontology hierarchy information.

Some aspects described herein relate to a computer program product. The computer program product may include one or more computer-readable storage media and program instructions stored on the one or more computer-readable storage media to perform operations. The operations may include obtaining, for a domain, ontology hierarchy information that indicates a structure that includes multiple levels of classes. The operations may include determining, based on the ontology hierarchy information, one or more navigational routes between multiple metaverse environments associated with the domain. The operations may include determining, based on the ontology hierarchy information, one or more access control parameters for respective metaverse environments of the multiple metaverse environments. The operations may include obtaining contextual information for a metaverse collaborative session that is associated with a metaverse environment of the multiple metaverse environments. The operations may include determining, for the metaverse environment, contextual access and navigational information based on the contextual information. The operations may include managing, during the metaverse collaborative session, access and information to the metaverse environment based on the contextual access and navigational information.

### BRIEF DESCRIPTION OF THE DRAWINGS

FIG. 1 is a diagram of an example computing environment for ontology-hierarchy-based metaverse navigation and collaboration described herein.

FIG. 2 is a diagram of an example of a structure of an ontology hierarchy described herein.

FIGS. 3A-3C are diagrams of an example associated with ontology-hierarchy-based metaverse navigation and collaboration.

FIG. 4 is a diagram of example components of a device associated with ontology-hierarchy-based metaverse navigation and collaboration.

FIG. 5 is a flowchart of an example process associated with ontology-hierarchy-based metaverse navigation and collaboration.

### DETAILED DESCRIPTION

The following detailed description of example implementations refers to the accompanying drawings. The same reference numbers in different drawings may identify the same or similar elements.

Virtual worlds, such as the metaverse, are digital environments that simulate real-world experiences or create new ones. The metaverse is a collective virtual shared space, created by the convergence of virtual reality (VR), augmented reality (AR), the internet, and other technologies. A metaverse environment enables users to interact with each other and digital objects in real time, and is used for various purposes, such as social interaction, entertainment, education, and/or collaboration.

Managing navigation and access in metaverse collaborations is a complex task due to the need to account for organizational hierarchies and dynamic changes in the collaboration environment. In metaverse collaborations, multiple users from different departments within an organization may participate, each with their own distinct roles and responsibilities. The organizational hierarchy of the participating users can be complex, with multiple levels of classes and relationships among them. Existing approaches to access control and collaboration in virtual environments (such as the metaverse) rely on static role-based access controls, which can be inflexible and difficult to manage in dynamic, real-time collaboration scenarios. These approaches may not account for the nuances of organizational hierarchies and the changing context of discussions within metaverse collaborations, making it challenging to manage navigation and access in accordance with organizational hierarchies. For example, roles and responsibilities of one or more users can overlap, and a given user may have multiple roles within an organization. This can lead to conflicts when applying static role-based access controls to metaverse collaborations. For example, each time there is a change in an organizational hierarchy, a user may manually reconfigure access permissions or navigation controls for multiple metaverse environments associated with the organization, thereby consuming processing resources, network resources, and/or memory resources, among other examples, associated with the manual reconfiguration.

Additionally, existing approaches often do not consider the changing context of discussions to activities being performed within metaverse collaborations. For example, a role or responsibilities of a user may change during a metaverse collaboration session, requiring dynamic updates to their access permissions. As another example, a discussion topic or activity being performed during a metaverse collaboration session may change, where the new discussion topic or activity is associated with different access permissions than a previous discussion or activity. However, traditional role-based access controls may not be able to accommodate these changes in real-time, leading to delays or errors in access control.

Further, existing approaches may not provide a clear and efficient way to manage navigation and access in accordance with organizational hierarchies. In a metaverse collaboration, a user may navigate through multiple environments, each with a dedicated set of access controls and permissions. Without a clear understanding of the organizational hierarchy and the relationships between different environments, it can be difficult to ensure that the user has the access permissions and can navigate the environments effectively and in accordance with the access permissions of the organizational hierarchy.

When access control and navigation parameters are not applied properly, a user may experience delays in accessing the data needed to perform one or more tasks. For example, a given user may need to access certain information or resources in a metaverse environment to collaborate with another user, but if the given user (or the metaverse collaboration session) does not have the correct access permissions, the given user may not be able to access the information in a timely manner during the metaverse collaboration session. This can lead to delays in accessing data and/or may consume resources (e.g., processing resources and/or network resources) associated with performing additional operations (e.g., data access operations) to access the data.

Further, if access control and navigation parameters are not applied properly, there is an increased risk of security incidents. For example, if a user has access to sensitive data that they should not have, they may inadvertently or intentionally share that information with others, compromising the security of the data. Similarly, if navigation controls are not in place, users may be able to access areas of the metaverse environment that they should not have access to, potentially leading to data breaches or other security incidents. As another example, if the context of a discussion or activity being performed during a metaverse collaboration session changes to a sensitive topic or sensitive data, there is a risk that a user who previously had permission to join and/or participate in the metaverse collaboration session (e.g., but does not have permission to access the sensitive topic or sensitive data in accordance with an organizational hierarchy) is able to view, hear, or otherwise access the sensitive topic or sensitive data, thereby increasing the risk of a security incident for the sensitive topic or sensitive data.

Additionally, as organizations grow and evolve, structures and relationships between departments can undergo transformations, leading to changes in the way that collaborations are conducted and information is shared. For example, an organization may acquire a new subsidiary, leading to the integration of new departments and teams, or the organization may undergo a restructuring, resulting in the consolidation of existing departments. Current methods for managing access control and navigation in metaverse environments may not be able to adapt to these changes, resulting in inefficiencies and potential security risks. For example, if a role of a user changes as a result of a restructuring, access permissions and navigation controls for the user may not be updated in a timely manner, leading to delays or the inability to access data or unauthorized access to sensitive information.

Some implementations described herein enable ontology-hierarchy-based metaverse navigation and collaboration. For example, a computer may dynamically manage access and navigation within metaverse environments based on an organizational ontology hierarchy. In some examples, the computer may obtain ontology hierarchy information for a domain. “Domain” refers to a set of entities, nodes, users, or teams, among other examples, that have structured relationships between them. The domain may be an organization, a company, an institution, a team, a department, a division, a group of users, a project, or another domain associated with a hierarchical structure. The ontology hierarchy information may indicate a structure that includes multiple levels of classes. A class may be an activity type, a process (e.g., a business process), a function, a collaboration or meeting type, a collaboration tool, a workflow, a task, a topic, and/or an action, among other examples. The ontology hierarchy information may indicate one or more relationships among the multiple levels of classes. The one or more relationships may be hierarchical relationships (e.g., parent-child relationships or superior-subordinate relationships), departmental relationships, collaborative relationships, project-based relationships (e.g., team member in a project), and/or an organizational chart relationship, among other examples. The computer may determine, based on the ontology hierarchy information, navigational routes between multiple metaverse environments associated with the domain. For example, the multiple metaverse environments may be associated with respective classes from the multiple classes. The computer may determine one or more access control parameters for respective metaverse environments based on the ontology hierarchy information. The one or more access control parameters may indicate one or more permissible users or permissible information types for the respective metaverse environments. The computer may manage, during a metaverse collaborative session, access and information to the metaverse environment based on the one or more access control parameters and the navigational routes.

In some examples, the computer may obtain contextual information for a metaverse collaborative session. The contextual information may indicate a purpose, a topic, an activity, a task, or another context for a particular metaverse collaborative session (or a portion of the metaverse collaborative session) taking place in a metaverse environment. For example, the metaverse collaborative session may be associated with a metaverse environment of the multiple metaverse environments associated with the domain. The computer may determine contextual access and navigational information based on the contextual information. For example, the contextual access and navigational information may include one or more updated access control parameters, and/or or one or more updated navigational routes for the metaverse environment. The computer may manage access and information to the metaverse environment based on the contextual access and navigational information.

As a result, the computer may reduce the complexity of managing navigation and access in metaverse collaborations by using ontology hierarchy information to optimize access control and information sharing protocols. By the computer determining the one or more access control parameters and/or the navigational routes based on the ontology hierarchy information, the computer may be enabled to quickly and easily adapt to changes in the domain, such as changes in the structure of the domain or changes in relationships among multiple levels of classes as indicated by the ontology hierarchy information. This may conserve resources (e.g., processing resources, network resources, and/or memory resources) by reducing the need for manual reconfiguration of access permissions or navigation controls for multiple metaverse environments. Additionally, by the computer determining the one or more access control parameters and/or the navigational routes based on the ontology hierarchy information, the computer may reduce latency and improve data accessibility during cross-metaverse navigation or collaboration by improving the likelihood that a user is able to access appropriate data during a given metaverse collaboration session (e.g., in a metaverse environment) from one or more other metaverse environments in accordance with the structure indicated by the ontology hierarchy information. This may conserve processing resources, memory resources, and/or network resources, among other examples, that would have otherwise been associated with the user performing one or more actions to obtain the data for the given metaverse collaboration session. Additionally, by the computer determining the one or more access control parameters and/or the navigational routes based on the ontology hierarchy information, the computer may improve the security of information or activities performed during a given metaverse collaboration session by ensuring that only users who are permitted to access the information or perform the activities (e.g., as indicated by the ontology hierarchy information) are able to access or navigate to the given metaverse collaboration session.

As an example, a user, such as a production manager, may utilize a metaverse environment to collaborate with other users, such as suppliers and team members, on a project. A computer may obtain contextual information, such as the meeting topic, attendees, and agenda, which may include a discussion of sensitive information. Based on this contextual information, the computer may generate contextual access and navigational information that restricts access to the sensitive information to only those who have a role that indicates they can access the sensitive information (e.g., as indicated by the ontology hierarchy information). The computer may determine a navigation path for the production manager that enables the production manager to easily access relevant information and resources from one or more other metaverse environments associated with the domain, such as design documents and production schedules, and to share them with the suppliers in real-time. In this example, the contextual information obtained by the computer may include the topic of the project, the attendees of the virtual meeting, and/or the agenda items to be discussed, among other examples. The contextual access and navigational information generated by the computer may include access control measures that restrict access to sensitive information to only those who are permitted to access the sensitive information, as well as navigation paths that provide one or more users with access to relevant information and resources from one or more other metaverse environments.

As a result, the computer may improve the likelihood that sensitive information is only accessible to authorized users, while also improving collaboration and communication between users. By the computer managing access and information to the metaverse environment based on the contextual access and navigational information, the computer may enable a secure and efficient way to manage access to sensitive information and navigate virtual environments, enabling users to work together more effectively and make informed decisions while also improving the security of sensitive information or topics.

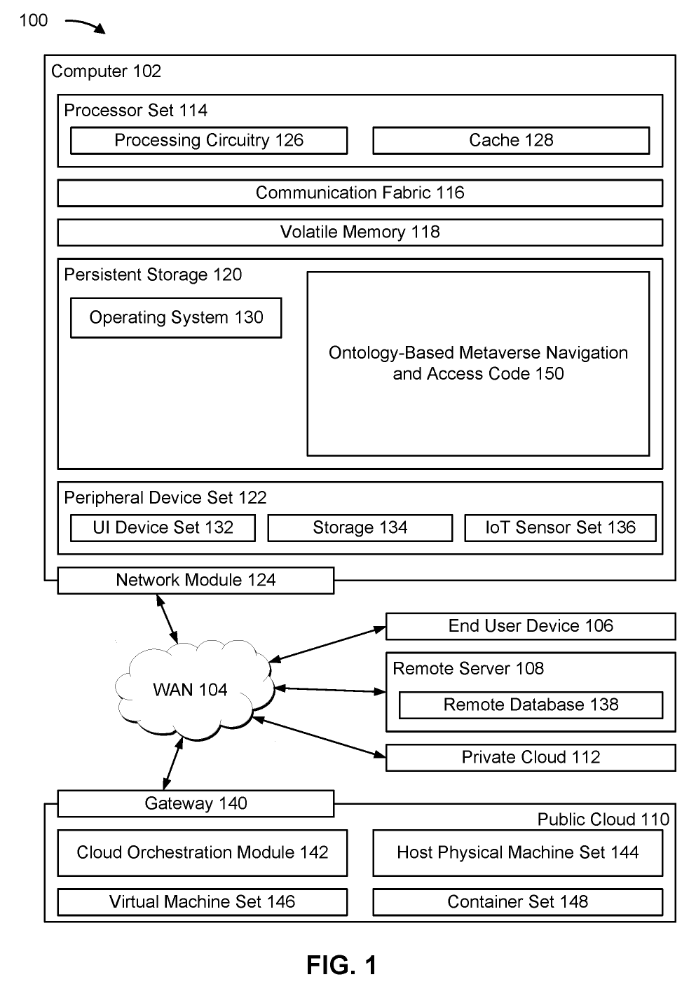

FIG. 1 is a diagram of an example computing environment 100 for ontology-hierarchy-based metaverse navigation and collaboration described herein.

The computing environment 100 contains an example of an environment for the execution of at least some of the computer code involved in performing the inventive methods, such as ontology-based metaverse navigation and access code 150. In addition to the ontology-based metaverse navigation and access code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the ontology-based metaverse navigation and access code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in the ontology-based metaverse navigation and access code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the ontology-based metaverse navigation and access code 150 includes at least some of the computer code involved in performing one or more operations described herein. The operations may include, for example, obtaining, for a domain, ontology hierarchy information that indicates a structure that includes multiple levels of classes. In some examples, the ontology hierarchy information indicates one or more relationships among the multiple levels of classes. The operations may include determining, based on the ontology hierarchy information, one or more navigational routes between multiple metaverse environments associated with the domain. In some examples, the multiple metaverse environments are associated with respective classes. The operations may include determining, based on the ontology hierarchy information, one or more access control parameters for respective metaverse environments of the multiple metaverse environments. In some examples, the one or more access control parameters indicate one or more permissible users or permissible information types for the respective metaverse environments. The operations may include obtaining contextual information for a metaverse collaborative session that is associated with a metaverse environment of the multiple metaverse environments. The operations may include determining, for the metaverse environment, contextual access and navigational information based on the contextual information. In some examples, the contextual access and navigational information indicates at least one of one or more updated access control parameters, or one or more updated navigational routes. The operations may include managing, during the metaverse collaborative session, access and information to the metaverse environment based on the contextual access and navigational information.

Additionally, or alternatively, the operations may include obtaining, for the domain, ontology hierarchy information that indicates the structure that includes multiple levels of classes. The operations may include determining, based on the ontology hierarchy information, one or more navigational routes between multiple metaverse environments associated with the domain. The operations may include managing access to a metaverse environment, of the multiple metaverse environments, based on a user role and the ontology hierarchy information. The operations may include updating the one or more navigational routes and access to the metaverse environment based on one or more changes in the ontology hierarchy information.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

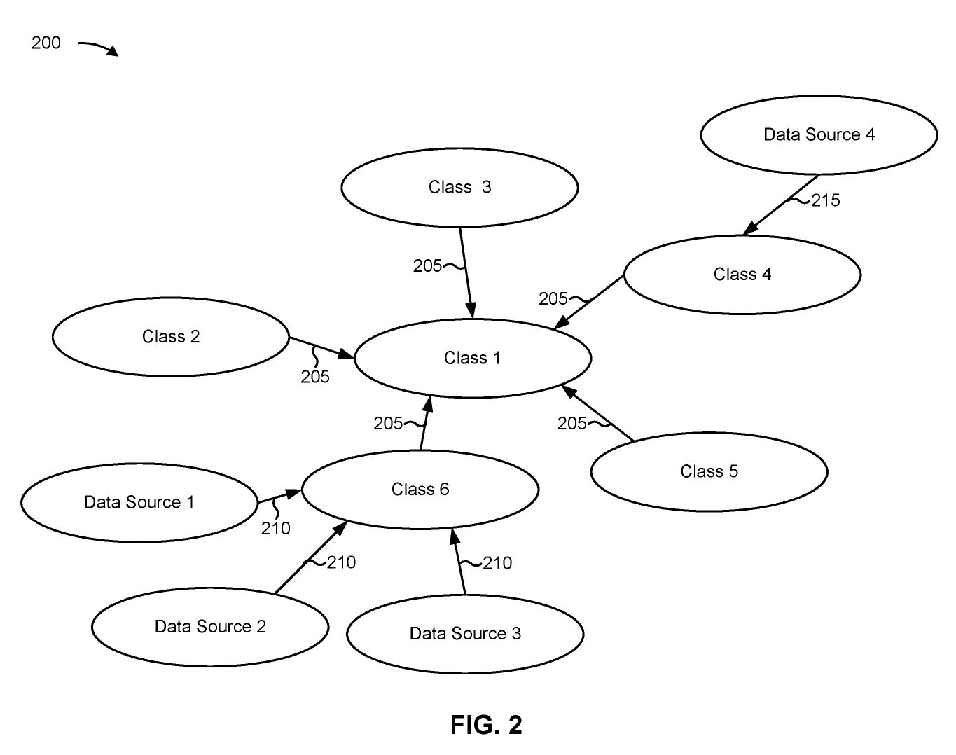

FIG. 2 is a diagram of an example 200 of a structure of an ontology hierarchy described herein. An ontology may be a description of knowledge as a set of concepts within a domain and the relationships that hold between them. For example, an ontology may define one or more components, such as individuals (e.g., instances of objects), activity types, and/or attributes, among other examples (e.g., collectively referred to herein as “classes”). The ontology may define relations, restrictions, rules, and/or axioms, among other examples, among the classes.

Ontology hierarchy information may be represented as an ontology data model. In some examples, an ontology data model may be applied to a set of individual facts to generate a knowledge graph. The knowledge graph may include a collection of entities (e.g., classes), where the types and relationships between the entities are represented by nodes and edges interconnecting the nodes. By defining the structural framework of knowledge within a domain, the ontology facilitates the creation of a knowledge graph that effectively captures and represents the data within the domain. By providing a standardized framework for representing data from diverse and disparate systems and databases, the ontology hierarchy information may enable interoperability between databases, facilitate cross-database searching, and/or streamline knowledge management, among other examples. In this way, the ontology hierarchy information may provide a unified modeling representation that enables the efficient integration and management of data from heterogeneous sources, thereby enhancing data accessibility and usability.

Ontology hierarchy information may enable automated reasoning about data (e.g., by a computer, such as the computer 102) by incorporating relationships between concepts or classes. This automated reasoning may be implementable in semantic graph databases that utilize ontology hierarchy information as the semantic schemata. Further, ontology hierarchy information may enable a computer (e.g., the computer 102) to process and reason with concepts and relationships in a manner analogous to human perception of interlinked concepts. In addition to facilitating automated reasoning, the ontology hierarchy information may provide a coherent and navigable framework, enabling a computer to seamlessly transition between concepts within the ontology structure. Additionally, ontology hierarchy information may be easily scaled, updated, or otherwise changed. Relationships and concept matching can be readily added to existing ontology hierarchy information, enabling the ontology hierarchy information to evolve in tandem with growing data volumes without disrupting dependent processes and systems.

In some examples, the ontology hierarchy information may be represented using a web ontology language. The web ontology language may be a semantic web language that utilizes computational logic to represent knowledge about entities and their interrelationships. Specifically, the web ontology language may provide a framework for distinguishing between classes, properties, and/or relationships, enabling the creation of detailed, consistent, and semantically meaningful representations of ontology hierarchy information for a domain. In some other implementations, the ontology hierarchy information may be represented in one or more data tables. For example, a hierarchical data structure can be used to represent relationships between classes and/or data sources. The hierarchical data structure may include one or more parent tables representing top-level concepts, one or more child tables representing lower-level concepts related to the top-level concepts, and/or one or more association tables establishing relationships between the concepts. This structure enables the representation of one-to-many, many-to-one, and many-to-many relationships between classes and/or data sources, facilitating efficient data analysis and retrieval. By leveraging this structure, ontology hierarchy information can be effectively represented, including class-subclass relationships, part-whole relationships, and/or associative relationships between concepts, among other examples.

FIG. 2 depicts an example structure that may be represented by ontology hierarchy information. As shown in FIG. 2, the structure may include multiple levels of classes (shown as two levels of classes for ease of description and depiction). For example, a first level may include a class 1. The class 1 may be a parent class. A parent class may be associated with a top-level concept or category in a hierarchical data structure. A second level may include a class 2, a class 3, a class 4, a class 5, and aclass 6. The classes in the second level may be child classes relative to the class 1, as indicated by the relationships 205. A child class may be associated with a lower-level concept or category in a hierarchical data structure. In some examples, one or more classes in the second level may have relationships among them (e.g., not shown in FIG. 2). Additionally, a given class may have multiple relationships with respective other classes.

A relationship between two or more classes may include different types of relationships. For example, a relationship may be a hierarchical relationship that can represent class-subclass relationships, where a subclass inherits properties and characteristics from its parent class. As another example, a relationship may be a part-whole relationship where a part is a component of a larger whole. As another example, a relationship may be an associative relationship, such as synonymy, hyponymy, and/or hypernymy, among other examples. Synonymy relationships may indicate that two or more classes are equivalent in meaning, while hyponymy relationships indicate that a class is a type or subtype of another class. Hypernymy relationships may indicate that a class is a broader category or supertype of another class. As another example, a relationship may be a component relationship (e.g., a component-of relationship where a class is a part or component of another class), an attribute-of relationship (e.g., where a class is an attribute or property of another class), a causal relationship (e.g., cause-effect and dependency relationships, where a class causes or influences another class, or depends on another class to function), a spatial relationship (e.g., containment relationships and adjacency relationships), and/or a temporal relationship (e.g., a sequence and duration relationship, where a class or concept occurs before, after, or simultaneously with another class, or exists for a specific duration or period). As another example, a relationship may be a logical relationship, such as an equivalence relationship (e.g., indicating that two or more classes are logically equivalent), and/or an implication relationship (e.g., indicating that a class implies or entails another class), among other examples.

For example, as shown in FIG. 2, the relationships 205 may indicate that the class1 is a parent class for the class 2, the class 3, theclass 4, the class 5, and the class 6. For example, a relationship may be associated with a directionality. The directionality may indicate that the relationship flows from one class to another or is a reciprocal or symmetrical relationship (e.g., a bidirectional relationship). For example, the directionality may be directed (e.g., A is a part of B, but not the reverse), undirected (e.g., A and B are related, but no direction is specified), reciprocal (e.g., A is part of B, and B is a part of A), conditional (e.g., A is related to B under condition C), and/or temporal (e.g., A is related to B at time T).

As shown in FIG. 2, the structure may indicate relationships (e.g., a relationship 210 or a relationship 215) between a class and one or more data sources. For example, the class 6 may have relationships 210 with a data source 1, a data source 2, and a data source 3. This may indicate that the class 6 uses, has access to, or otherwise can interact with the data source 1, the data source 2, and the data source 3. As another example, the class 4 may have a relationship 215 with a data source 4. This may indicate that the class 4 uses, has access to, or otherwise can interact with the data source 4.

As an example, the structure depicted in FIG. 2 may be associated with an organization that produces one or more products. The class 1 may be associated with a production management team. Theclass 2 may be associated with a supplier, theclass 3 may be associated with environmental information, the class 4 may be associated with a human resources team, the class 5 may be associated with component information, and the class 6 may be associated with an inventory and schedule team. In such examples, the production management team may be permitted to access or collaborate with the supplier, the environmental information, the human resources team, the component information, and the inventory and schedule team. However, the inventory and schedule team may not be permitted to access and/or collaborate with information associated with the human resources team in accordance with the organization structure. In some examples, the data source 1 may be an inventory data source, the data source 2 may be an inventory cost data source, and a component in a production data source. The data in these data sources may be relevant to, or used by, the inventory and schedule team. However, the human resources team may not be permitted to access the inventory and schedule data as such data may not be relevant to the functions or activity of the human resources team. The data source 4 may be a type of work or a number or workers data source. For example, such data may be relevant to the functions or activity of the human resources team, so the organization structure may indicate that the human resources team can access such data.

FIG. 2 is provided as an example. Other examples may differ from what is described with regard to FIG. 2.

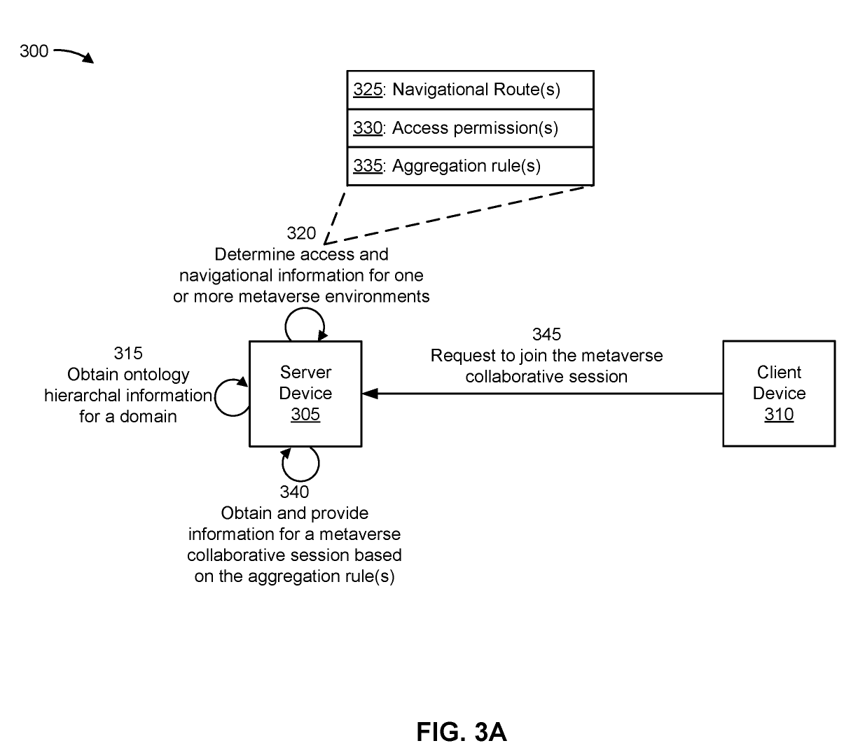

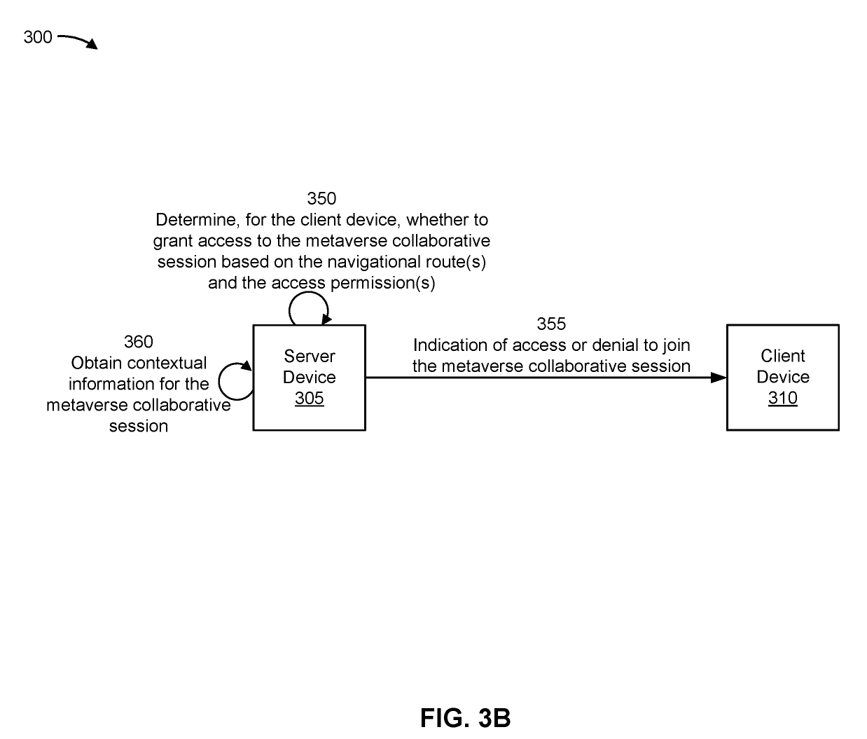

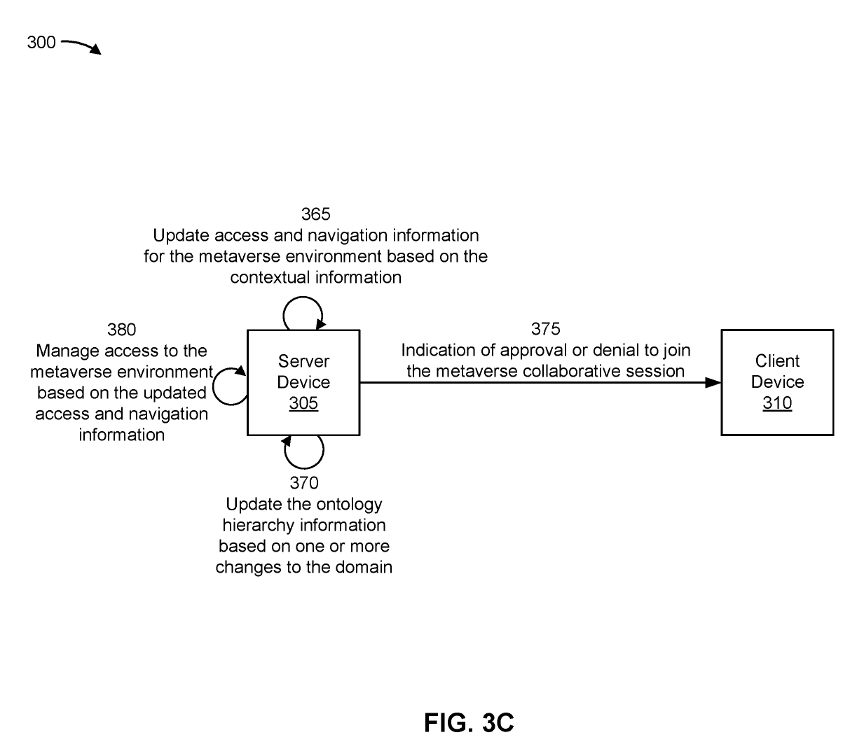

FIGS. 3A-3C are diagrams of an example 300 associated with ontology-hierarchy-based metaverse navigation and collaboration. As shown in FIGS. 3A-3C, example 300 includes a server device 305 (e.g., a first computer 102) and a client device 310 (e.g., a second computer 102).

The server device 305 may be, or may include, a metaverse server. A metaverse server may be configured to host, manage, and/or facilitate metaverse collaborative sessions, such as generating and adapting personalized virtual layouts described herein. Additionally, the metaverse server may process user input, and/or synchronize interactions among multiple users in real-time, among other examples. Additionally, the metaverse server may perform user authentication, perform data storage for a metaverse environment or session, and/or generate, render, and/or arrange virtual objects and environments, among other examples. The client device 310 may be, or may include, a metaverse client. A metaverse client may be configured to render and/or display personalized virtual layouts received from a metaverse server (e.g., the server device 305), as described herein. Additionally, the metaverse client may capture and transmit user input, such as movements and interactions, to the server device 305 for processing. The metaverse client may perform local rendering of virtual objects, process sensory data, and/or provide real-time feedback to a user, among other examples.

As shown in FIG. 3A, and by reference number 315, the server device 305 may obtain ontology hierarchical information for a domain. The ontology hierarchical information may indicate a structure that includes multiple levels (e.g., of classes). For example, the ontology hierarchical information and the structure may be similar to the ontology hierarchical information and structure described in connection with FIG. 2. As an example, the server device 305 may obtain a knowledge graph, a hierarchical data structure, and/or code written in a web ontology language, among other examples, that indicate the ontology hierarchical information. The ontology hierarchical information may indicate different levels representing varying depths and breadths of navigation paths (e.g., among classes in various levels). In some examples, the ontology hierarchical information may indicate defined level of cardinality and aggregation functions between different levels of the structure. “Cardinality” may refer to the quantity of relationships a given class has (or a quantity of relationships between two or more classes).

This enables the server device 305 to traverse the ontology hierarchy and identify relevant information, relationships, and/or dependencies between classes. For example, the server device 305 can use the ontology hierarchical information to understand the complex relationships between classes and entities in the domain, and navigate the ontology hierarchy to identify relevant information, dependencies, and/or relationships. This enables the server device 305 to determine access and navigational information for one or more metaverse environments in accordance with a hierarchical structure of the domain, as described in more detail elsewhere herein.

As an example, in a domain related to supply chain management, the ontology hierarchical information may indicate a structure with multiple levels, including a top-level class representing “Supply Chain”, with subclasses representing “Manufacturing”, “Logistics”, and “Distribution.” Each of these subclasses may have further subclasses, such as “Raw Materials” and “Finished Goods” under “Manufacturing”, and “Transportation” and “Warehousing” under “Logistics.”

As shown by reference number 320, the server device 305 may determine access and navigational information for metaverse environments. For example, the domain may be associated with the metaverse environments (e.g., multiple metaverse environments or multiple sessions within a given metaverse environment). The server device 305 may use the ontology hierarchical information to inform and govern the management of the metaverse environments. For example, the server device 305 may manage access and navigation in the metaverse environments by leveraging the structured knowledge and relationships defined in the ontology hierarchical information. The server device 305 may analyze the ontology hierarchical information to identify the relationships between different classes and entities. This may enable the server device 305 to determine access control parameters and navigational routes that apply to each metaverse environment. By dynamically determining which users or entities have permission to access specific metaverse environments, and what information or resources they are authorized to access within those metaverse environments, the server device 305 enables fine-grained control over access and navigation in the metaverse. This enables more secure, efficient, and context-aware management of virtual collaborations and interactions in accordance with a hierarchical structure indicated by the ontology hierarchical information.

For example, as shown by reference number 325, the server device 305 may determine one or more navigational routes between two or more metaverse environments. As used herein, “navigational route” refers to a permitted path or connection (e.g., one or more permissible routes) between two or more metaverse environments. A navigation route may enable avatars of users to move between the two or more metaverse environments and/or share information between the two or more metaverse environments. For example, a navigational route may include a permitted route for a user to move from one metaverse environment to another, based on a role, permissions, and/or other factors. Additionally, or alternatively, a navigational route may be a designated path for information sharing between metaverse environments, enabling data, files, and/or other digital assets to be exchanged or accessed between different metaverse environments.

The server device 305 may determine, based on the ontology hierarchy information, one or more navigational routes between multiple metaverse environments associated with the domain. As described elsewhere herein, the multiple metaverse environments may be associated with respective classes (or respective levels of classes) indicated by the ontology hierarchical information. For example, a metaverse environment for production may be associated with a class of production-related activities, while a metaverse environment for human resources (HR) may be associated with a class of HR-related activities. The navigational routes determined by the server device 305 enable users to move between these different metaverse environments, facilitating collaboration and information sharing between teams and departments. The ontology hierarchy information ensures that these navigational routes are determined in a way that is in accordance with the relationships and dependencies between different classes or levels of classes.

For example, if a user is participating in a metaverse collaborative session associated with a production-related activity, the server device 305 may determine a navigational route to a metaverse environment associated with a related activity, such as inventory management or supply chain logistics. This enables the user to access relevant information and collaborate with others in a way that is consistent with the ontology hierarchy. In some examples, a navigational route may be based on a relationship indicated by the ontology hierarchy information.

For example, the server device 305 may analyze or parse the ontology hierarchy information to identify the relationships between different metaverse environments and the classes or levels of classes that the metaverse environments are associated with. The server device 305 may retrieve role and permission data for a user from a database or other storage system. The server device 305 may analyze the role and permission data to determine the access rights and privileges within the metaverse. Additionally, the server device 305 may analyze the context of the metaverse collaborative session, including factors such as the topic being discussed, the participants involved, and the agenda, to determine the relevance and importance of different metaverse environments and the information they contain.

Based on the results of these analyses, the server device 305 may determine the navigational route by applying rules and algorithms that take into account the ontology hierarchy, user roles and permissions, and/or contextual information, among other examples. The navigational route may be stored in a data structure (such as a graph data structure, a table or database, or a JavaScript object notation (JSON) or extensible markup language (XML) document) that represents the navigational route. This data structure is stored in a database or other storage system (such as a relational database management system (RDBMS), a not only structured query language (NoSQL) database, or a graph database) to enable efficient querying and retrieval of navigational route information. When a user requests to navigate between metaverse environments, the server device 305 may query the stored navigational route data structure to determine whether the request is permitted and to retrieve the necessary information to facilitate the navigation. This enables secure, controlled, and efficient collaboration and information sharing between users in different metaverse environments.

As shown by reference number 330, the server device 305 may determine one or more access permissions for the one or more metaverse environments. For example, the server device 305 may determine, for one or more of the metaverse environments, one or more access control parameters (e.g., that indicate access permissions for one or more users and/or types of information to be made available in a given metaverse environment). In some examples, the server device 305 may determine the access permissions based on the ontology hierarchical information. For example, the server device 305 may determine, based on the ontology hierarchy information, one or more access control parameters for respective metaverse environments of the multiple metaverse environments associated with the domain. The one or more access control parameters may indicate one or more permissible users (or prohibited users) or permissible information types (or prohibited information types) for the respective metaverse environments.

In some implementations, the server device 305 may determine the one or more access permissions for the one or more metaverse environments based on the ontology hierarchical information by analyzing the relationships between the different levels of classes in the ontology hierarchy. For example, the server device 305 may analyze the parent-child relationships between the classes in the ontology hierarchy to determine the access permissions for a particular metaverse environment. If a user has access to a parent class, the server device 305 may automatically grant access to the one or more child classes that are associated with that parent class. Conversely, if a user does not have access to a parent class, the server device 305 may deny access to the child classes that are associated with that parent class. The server device 305 may also analyze the sibling relationships between the classes in the ontology hierarchy to determine the access permissions for a particular metaverse environment. For example, if two classes are siblings, the server device 305 may grant access to a user who has access to one of the sibling classes.

In some implementations, the server device 305 may analyze the attributes and properties of the classes to determine the access permissions for a particular metaverse environment. For example, if a class has an attribute that indicates that information or activities associated with the class is confidential, the server device 305 may deny access to that class to users who do not have the necessary clearance as indicated by the ontology hierarchical information. In some examples, the server device 305 may also use reasoning algorithms to infer access permissions based on the ontology hierarchical information. For example, if a user has access to a class that is a subclass of a parent class, the server device 305 may infer that the user also has access to the parent class. In some examples, the server device 305 may also use description logic to reason about the access permissions. Description logic is a family of formal knowledge representation languages that can be used to represent and reason about ontologies. The server device 305 may use description logic to define a set of rules and axioms that govern access to the metaverse environments, and then use a description logic reasoner to infer access permissions based on the ontology hierarchical information.

In some implementations, the server device 305 may also use other techniques, such as inheritance, polymorphism, and/or encapsulation, among other examples, to determine access permissions based on the ontology hierarchical information. For example, the server device 305 may use inheritance to inherit access permissions from parent classes to child classes. This means that if a parent class has a certain access permission, the child classes will also inherit that access permission. The server device 305 may also use polymorphism to enable objects of different classes to be treated as if they were of the same class for the purposes of access control. This means that if a user has access to a class, they will also have access to objects of other classes that are polymorphic with that class. The server device 305 may also use encapsulation to hide the internal details of the classes and only expose the necessary information to the users. This means that the users will only see the interface(s) of the classes and not the internal implementation details, which can help to improve the security and integrity of the system.

In some examples, the one or more access control parameters may include role-based access control, attribute-based access control, and/or policy-based access control, among other examples. In role-based access control, access permissions may be granted based on the roles assigned to users. In role-based access control, access permissions are granted based on attributes associated with users, such as their department, job function, or clearance level. Policy-based access control involves granting access permissions based on a set of policies that are defined by the organization. As another example, the server device 305 may also employ other access control mechanisms, such as identity and access management (IAM) systems. IAM systems involve managing the identities of users and devices, and granting access permissions based on these identities. This may involve using techniques such as single sign-on (SSO), multi-factor authentication (MFA), and/or identity federation, among other examples.

In some implementations, the server device 305 may utilize one or more machine learning algorithms to determine access permissions for users in the metaverse environments. This may involve the server device 305 analyzing the behavior of users in the metaverse environments, such as their interactions with virtual objects, other users, and the environment itself. The server device 305 may employ various machine learning techniques, such as anomaly detection, predictive analytics, and/or recommendation systems, among other examples, to identify patterns and anomalies in user behavior that may inform access permission decisions. For example, the server device 305 may use anomaly detection algorithms to identify unusual patterns of behavior that may indicate a security threat or a need to adjust access permissions.

As shown by reference number 335, the server device 305 may determine one or more aggregation rules for a metaverse environment. An aggregation rule may indicate one or more types of information (e.g., information related to user interactions, virtual objects, and/or other data that is relevant to the metaverse environment) to be aggregated and/or made available for a given metaverse environment. Additionally, or alternatively, an aggregation rule may indicate one or more metaverse environments from which information is to be aggregated or collected to be made available for a given metaverse environment. For example, an aggregation rule may specify that information from a first metaverse environment, such as a virtual meeting room, should be aggregated with information from a second metaverse environment, such as a virtual whiteboard, to provide a comprehensive view of a project’s progress.

The multiple levels of classes in the ontology hierarchy may be associated with respective sets of one or more aggregation rules that are based on the ontology hierarchy information. The server device 305 may determine the sets of one or more aggregation rules based on the ontology hierarchy information, taking into account the relationships between the different classes and the attributes and properties of each class. In some implementations, the server device 305 may use the ontology hierarchy information to infer aggregation rules based on the relationships between the classes. For example, if a first class is a subclass of a second class, the server device 305 may infer that the aggregation rules for the first class should be a subset of the aggregation rules for the second class. As another example, if a first class is a parent class of a second class, then the server device 305 may determine an aggregation rule that indicates that data associated with the second class is to be made available for metaverse sessions or metaverse environments associated with the first class.

The server device 305 may also use the ontology hierarchy information to determine the scope of the aggregation rules. For example, if a class has a property that indicates that the class is confidential, the server device 305 may determine that the aggregation rules for that class should only allow information to be aggregated from other classes that have the same confidentiality property. The server device 305 may also use other factors to determine the one or more aggregation rules, such as user preferences, security policies, and/or data provenance, among other examples.

For example, the server device 305 may use user preferences to determine which types of information to aggregate and make available for a given metaverse environment. A user may specify, for example, that the user only wants to see information related to a specific project or topic, and the server device 305 may use that information to determine the aggregation rules. The server device 305 may also use security policies to determine the aggregation rules. For example, a security policy may specify that certain types of information should only be aggregated for users with a certain level of clearance, and the server device 305 may use that information to determine the aggregation rules. In some examples, the server device 305 may use data provenance to determine the aggregation rules. “Data provenance” refers to the origin and history of data, and the server device 305 may use this information to determine which data to aggregate and make available for a given metaverse environment.

The server device 305 may manage access and information for a metaverse environment (e.g., for a metaverse session within the metaverse environment) based on the access and navigational information for that metaverse environment. For example, the server device 305 may manage access and information for a metaverse environment based on one or more navigational routes, one or more access permissions, and/or one or more aggregation rules, among other examples, for that metaverse environment (e.g., as determined as described in connection with reference number 320, reference number 325, reference number 330, and/or reference number 335). For example, managing access and information for the metaverse environment may include granting access to the metaverse environment, denying access to the metaverse environment, or providing access to information for the metaverse environment, among other examples.

For example, the server device 305 may control which users have access to metaverse environments associated with different levels of the structure indicated by the ontology hierarchy information, and what actions the users can perform within those metaverse environments. For example, a user may have access to a lower level of the hierarchy, but not to higher levels. The system may also control the navigation of participants from one metaverse collaborative environment to another. This means that the system will determine which users can move from one environment to another, and what actions they can perform in each environment based on the ontology hierarchy information.

In addition to managing access to different levels of the hierarchy, the server may manage the aggregation of features or information from different child levels within the ontology hierarchy to parent levels. This means that the system will collect and combine data and features from metaverse environments associated with one or more first levels and make the features and/or data available at metaverse environments associated with one or more second levels. For example, a user at a parent level may be able to view data and features from metaverse environments associated with one or more child levels, and perform actions that affect all of those levels. By controlling access to different levels of the hierarchy via the metaverse environments, managing the navigation of participants from one metaverse collaborative environment to another, and managing the aggregation of features from different child levels within the ontology hierarchy to parent levels, the server device 305 may improve the likelihood that users have the access and abilities they need to perform tasks effectively, while also protecting the security and integrity of data based on the ontology hierarchy information.

For example, as shown by reference number 340, the server device 305 may obtain and/or provide information for a metaverse collaborative session (e.g., within a given metaverse environment) based on one or more aggregation rules. The given metaverse environment may be associated with a first class (e.g., a first level of class) as indicated by the ontology hierarchy information. The server device 305 may use the one or more aggregation rules to identify relevant information from one or more metaverse collaborative sessions associated with one or more second levels of classes. For example, the server device 305 may execute one or more aggregation rules (e.g., associated with a first metaverse environment) to collect information from a second metaverse environment. The server device 305 may provide the information to the first metaverse environment. The one or more aggregation rules may be based on the ontology hierarchy information, as described in more detail elsewhere herein.

For example, the server device 305 may identify, based on a set of one or more aggregation rules, one or more metaverse collaborative sessions associated with one or more second levels of classes. The set of one or more aggregation rules may be associated with a first level of class. In some examples, the first level of class may be a parent level and the one or more second levels of classes may be child levels with respect to the first level as indicated by the ontology hierarchy information.

The server device 305 may obtain session information for the metaverse collaborative session from the one or more metaverse collaborative sessions. The session information may include, for example, data related to the users participating in the session, the topics being discussed, and the virtual objects being manipulated. For example, the server device 305 may access a database that stores data related to user interactions within a metaverse environment, or access an external data source that provides real-time data for another metaverse environment.

The server device 305 may provide the session information to be available during the metaverse collaborative session. For example, the server device 305 may display the session information in a user interface of the metaverse environment, or provide it as input to an application or service running in the metaverse environment. To make the data available for the metaverse collaborative session, the server device 305 may store the data in a centralized data repository or a distributed data store, such as a data lake or a data warehouse. The server device 305 may also use various data processing techniques, such as data aggregation, data filtering, or data sorting, to prepare the data for analysis and visualization. The server device 305 may make the data available through various interfaces, such as application programming interfaces (APIs), data feeds, or user interfaces, among other examples. For example, the server device 305 may provide an API that enables applications associated with the metaverse collaborative session to access the data, or display the data in a user interface of the metaverse environment during the metaverse collaborative session.

For example, the server device 305 may update the metaverse environment based on the one or more aggregation rules. In some examples, the updates may be performed in real-time or through periodic summaries. Real-time updates may be used in situations where the data is highly dynamic or where the participants require immediate access to the most up-to-date information. For example, in a financial trading environment, real-time updates may be necessary to ensure that traders have access to the most current market data. In another example, periodic summaries may be used where the data is relatively static or where the participants can tolerate some delay in receiving updates. For example, in a project management environment, periodic summaries may be sufficient to provide team members with an overview of the progress of the project.

The server device 305 may use various techniques to perform the updates, such as data propagation, data fusion, and/or data aggregation, among other examples. Data propagation involves propagating the updated data from one or more metaverse environments (e.g., associated with one or more child levels) to the metaverse environment (e.g., associated with the parent level), using the aggregated rules to determine how the data should be combined. Data fusion may involve combining the data from multiple metaverse environments (e.g., associated with respective child levels or classes) into a single, unified view at the metaverse environment (e.g., associated with the parent level). Data aggregation may involve aggregating the data from multiple metaverse environments (e.g., associated with respective child levels or classes) into a summarized view at the metaverse environment (e.g., associated with the parent level).

In some examples, the server device 305 may use a publish-subscribe model to perform the updates. In this example, a metaverse environment (e.g., associated with a child level or class) may publish updated data to a central hub, and the metaverse environment (e.g., associated with the parent level) may be subscribed to the central hub to receive the updated data. The central hub may use the one or more aggregation rules to determine how the data should be combined, and update the metaverse environment accordingly.

In some examples, the server device 305 may use a peer-to-peer model to perform the updates. In these examples, metaverse environments (e.g., associated with child levels or classes) may communicate directly with the metaverse environment (e.g., associated with the parent level) to exchange updated data. The metaverse environments (e.g., associated with child levels or classes) may use the aggregated rules to determine how the data should be combined and update the metaverse environment (e.g., associated with the parent level).

In some examples, the server device 305 may also use the aggregation rules to filter or prioritize the session information. For example, if there are multiple metaverse collaborative sessions associated with a given class, the server device 305 may use the aggregation rules to determine which sessions are most relevant and should be prioritized. The server device 305 may also use the aggregation rules to determine the level of access that users have to the session information. For example, if a user is associated with a parent level of class, the server device 305 may grant the user access to session information from all child levels of classes associated with that parent level. In some examples, the server device 305 may use the ontology hierarchy information to determine the relationships between the different classes and adjust the aggregation rules accordingly. For example, if a new class is added to the ontology hierarchy, the server device 305 may automatically update the aggregation rules to reflect the new relationship(s) indicated by changes in the ontology hierarchy information.

As shown by reference number 345, the client device 310 may transmit or provide, and the server device 305 may obtain or receive, a request to join the metaverse collaborative session. The request may be initiated by a user who wishes to participate in the metaverse collaborative session. The request may include user information, such as the identity, the type of device being used, and the metaverse environment in which the user wishes to participate. The client device 310 may transmit the request to the server device 305 using various communication protocols and may include additional information such as authentication credentials or encryption keys to secure the transmission.

As shown in FIG. 3B, and by reference number 350, the server device 305 may determine whether to grant access to the metaverse collaborative session (e.g., for the client device 310 and/or the user) based on the one or more navigational routes and/or the one or more access permissions for the metaverse environment in which the metaverse collaborative session is occurring or is to occur. For example, after receiving the request, the server device 305 may process the request and determine whether to grant or deny access to the metaverse collaborative session. This may involve verifying the identity and permissions of the user, checking the availability of resources and capacity within the metaverse environment, and/or evaluating any potential security risks or conflicts.

In addition, the server device 305 may evaluate the role and responsibilities of the user within the organization, as well as the level of expertise and experience of the user, to determine whether the user has the necessary permissions to access the metaverse collaborative session (e.g., based on one or more access control parameters for the metaverse environment). The server device 305 may also determine the availability of resources and capacity within the metaverse environment, such as the number of users currently participating in the metaverse collaborative session, the amount of available bandwidth, and/or the processing power required to support the metaverse collaborative session, among other examples. The server device 305 may enforce one or more access control parameters for the metaverse environment at different levels of granularity. For example, the server device 305 may enforce one or more access control parameters at the level of individual metaverse environments, or at the level of individual users or groups of users.

As shown by reference number 355, the server device 305 may transmit, and the client device 310 may receive, an indication of access or denial to join the metaverse collaborative session. For example, based on the one or more access control parameters, the server device 305 may determine whether the user has permission to access the metaverse collaborative session. As another example, based on the one or more navigational routes, the server device 305 may determine whether the user has permission to navigate to the metaverse environment in which the metaverse collaborative session is occurring or is to occur.

If the request is granted, the server device 305 may provide the client device 310 with access to the metaverse collaborative session. The server device 305 may transmit relevant data to the client device 310, such as 3D models, textures, and/or audio streams, among other examples. Additionally, the server device 305 may establish communication channels for real-time interaction with other users, enabling seamless collaboration and communication within the metaverse environment. The client device 310 may render the metaverse environment and provide the user with an immersive and interactive experience within the metaverse environment.

If the request is denied, the server device 305 may transmit an indication of denial to the client device 310. In some examples, the indication of the denial may include the reason for the denial. The client device 310 may display a message or notification to the user and provide options to retry the request or seek additional information. The server device 305 may also maintain a record of denied requests to improve access control and navigational routing mechanisms, and provide alternative options or suggestions for accessing the metaverse collaborative session or related resources.

As shown by reference number 360, the server device 305 may obtain contextual information for the metaverse collaborative session. The contextual information may indicate one or more participating users, a topic being discussed, an activity being performed, and/or a function being performed, among other examples. For example, the contextual information may include sentiment analysis information, participant information, topic information, and/or agenda information, among other examples. The sentiment analysis information may indicate an emotional tone, opinions, and attitudes of the participating users in the metaverse collaborative session. The participant information may indicate details about the users participating in the metaverse collaborative session, such as a role, department, expertise, and/or other relevant details. The topic information may indicate a subject matter being discussed or addressed, or an action or function being performed, during the metaverse collaborative session. The agenda information may indicate a planned schedule, a goal, and/or an objective of the metaverse collaborative session, such as the purpose, one or more key discussion points, and/or one or more desired outcomes, among other examples, of the metaverse collaborative session (e.g., the agenda information may be indicated by, or included in, an agenda for the metaverse collaborative session).

The server device 305 may obtain the contextual information through one or more methods and technologies. For example, the server device 305 may obtain the sentiment analysis information using natural language processing (NLP) techniques applied to the text-based communication (or a transcript of voice-based communication) occurring within the metaverse collaborative session. For example, the server device 305 may analyze the language used by the participating users to determine an emotional tone, opinions, and/or attitudes, which can provide valuable insights into the dynamics of the collaboration. The server device 305 may obtain the participant information from one or more user profiles, which may contain information such as the role, department, and/or expertise, among other examples, of respective users participating in the metaverse collaborative session.

The server device 305 may obtain the topic information and/or the agenda information through NLP techniques and/or analysis of metadata associated with the metaverse collaborative session. For example, the server device 305 may analyze a chat log or conversation transcripts to identify key phrases, keywords, and/or entities, which can help to determine the topic being discussed during the metaverse collaborative session. Agenda information, such as the purpose, goals, and/or schedule of the metaverse collaborative session, may be gathered through integration with a calendaring system or other collaboration tools. By gathering and analyzing this contextual information, the server device 305 can gain a deeper understanding of the metaverse collaborative session, which can be used to inform decisions on access control, information sharing, and navigation, among other aspects of the collaboration experience.

As shown in FIG. 3C, and by reference number 365, the server device 305 may update the access and navigation information for the metaverse environment based on the contextual information of the metaverse collaborative session occurring within the metaverse environment. For example, the server device 305 may determine, for the metaverse environment, contextual access and navigational information based on the contextual information. The contextual access and navigational information may be based on the access and navigational information determined for the metaverse environment (e.g., as described in connection with FIG. 3A and reference numbers 320 through 335). The contextual access and navigational information may update or modify at least a portion of the original access and navigational information determined for the metaverse environment based on the contextual information of the metaverse collaborative session. In some examples, the contextual access and navigational information may indicate one or more updated access control parameters, and/or or one or more updated navigational routes, among other examples, for the metaverse environment.

In some examples, the server device 305 may update, based on the contextual information, the metaverse collaborative session to be associated with a second level of class from the multiple levels of classes associated with the structure indicated by the ontology hierarchy information. This may cause the metaverse environment to be associated with access and navigation information that is determined for the second level of class (e.g., as described in connection with FIG. 3A and reference numbers 320 through 335). For example, the metaverse environment may be associated with a first level of class (or a first class) from the multiple levels of classes associated with the structure indicated by the ontology hierarchy information. The original access and navigational information determined for the metaverse environment may be based on the first level of class (or the first class). Based on the contextual information, the server device 305 may update the metaverse environment to be associated with the second level of class (or a second class). The contextual access and navigational information may be based on the second level of class (or the second class), determined by the server device 305 as described in connection with FIG. 3A and reference numbers 320 through 330. For example, the metaverse environment may be associated with a lower-level class or a child class in the structure indicated by the ontology hierarchy information. However, the contextual information may indicate that the metaverse collaborative session is associated with a topic, activity, and/or function that is typically associated with a higher-level or parent class in the structure indicated by the ontology hierarchy information.

Therefore, the server device 305 may update the access and navigation information for the metaverse environment to indicate contextual access and navigational information that is associated with the higher-level or the parent class. This reduces the risk of security incidents that could be caused by discussing sensitive topics or information (e.g., typically discussed in context of the higher-level or the parent class) in a metaverse environment that is configured with access and navigational information determined for the lower-level class or the child class. Additionally, this may improve the likelihood that users in the metaverse collaborative session will have access to data relevant to the metaverse collaborative session (e.g., because the access and navigational information determined for the lower-level class or the child class may otherwise restrict access to data relevant to the metaverse collaborative session).

In some examples, the contextual access and navigational information may indicate one of updated permissible users, updated permissible information types, and/or updated navigational routes, among other examples, for the metaverse environment. For example, the updated permissible users may include an updated list of users who are authorized to access the metaverse environment, participate in the metaverse collaborative session, and/or view information within the metaverse environment. The updated list may be based on the contextual information, such as the topic being discussed, the sentiment of the participants, or the goals of the collaboration. For example, if the topic being discussed is confidential, then the updated permissible users may be restricted to only those with proper clearance or authorization for the topic or context of the metaverse collaborative session.

The updated permissible information types may include an updated list of information that can be shared or accessed within the metaverse environment. The updated list may be based on the contextual information, such as the goals of the collaboration, the participants’ roles, or the topic being discussed. For example, if the goal of the collaboration is to share sensitive information, then updated permissible information types may include types of information that are relevant for the collaboration or may be relevant to the discussion of the sensitive information. The updated navigational routes may include revised pathways or links between different areas of the metaverse environment, or between different metaverse environments, based on the contextual information gathered during the session. For example, the server device 305 may restrict access for navigation to the metaverse environment during the metaverse collaborative session based on the contextual information (e.g., based on the contextual information indicating a sensitive or important topic is being discussed). As another example, the server device 305 may restrict access for navigation to a portion of the metaverse environment (such as a virtual room or other area) in which the metaverse collaborative session is taking place based on the contextual information. The server device 305 may apply such restrictions in real-time, dynamically adjusting access permissions based on the context of the metaverse collaborative session. By restricting access to the metaverse environment or a portion thereof, the server device 305 can reduce the likelihood of unauthorized disclosure of sensitive information, maintain confidentiality, and/or ensure that only authorized users have access to the relevant information and discussions taking place during the metaverse collaborative session, among other examples.

The server device 305 may update the access and navigation information for the metaverse environment based on one or more benchmarks or thresholds related to the contextual information of the metaverse collaborative session. For example, the benchmarks may include changes in sentiment analysis, participant activity, topic relevance, and/or agenda progress, among other examples. For example, the server device 305 may update the access and navigation information for the metaverse environment based on a sentiment analysis that indicates a shift in emotional tone, such as a sudden increase in negative sentiment (e.g., if a change in a percentage of a negative sentiment satisfies a threshold within a time window) or a prolonged period of high anxiety (e.g., if an anxiety level satisfies a threshold for time period), indicating a potential conflict or issue that requires adjusted access control. As another example, if agenda information includes one or more key words (e.g., indicating a sensitive or important topic), then the server device 305 may update the access and navigation information for the metaverse environment. As another example, if the server device 305 detects a certain quantity of key words (e.g., based on NLP analysis of a discussion occurring during the metaverse collaborative session) within a given time period, then the server device 305 may update the access and navigation information for the metaverse environment. As another example, the server device 305 may update the access and navigation information based on detecting a completion or transition of a task or topic (e.g., indicated by the agenda information).

As shown by reference number 370, the server device 305 may manage access to the metaverse environment based on the contextual access and navigational information. For example, the server device 305 may manage, during the metaverse collaborative session, access and information to the metaverse environment based on the contextual access and navigational information. In some examples, the server device 305 may use the contextual access and navigational information for managing access and information to the metaverse environment for a duration of the metaverse collaborative session. For example, after the metaverse collaborative session ends, the server device 305 may apply the original access and navigational information for the metaverse environment (e.g., determined by the server device 305 as described in connection with FIG. 3A and reference numbers 320 through 335). Additionally, or alternatively, the server device 305 may use the contextual access and navigational information for managing access and information to the metaverse environment until the contextual information of the metaverse collaborative session indicates that a context of the metaverse collaborative session has changed.

For example, the managing of access and information to the metaverse environment may include granting access to the metaverse collaborative session, denying access to the metaverse collaborative session, and/or providing (or restricting) access to information for the metaverse collaborative session, among other examples. As an example, and as shown by reference number 375, the server device 305 may transmit, and a client device 310 may receive, an indication of approval or denial to join the metaverse collaborative session based on the contextual access and navigational information. For example, the server device 305 may receive a request for a user to participate in the metaverse collaborative session. One or more access control parameters (e.g., indicated by the original access and navigational information associated with the metaverse environment as described in connection with FIG. 3A and reference numbers 320 through 335) may indicate that the user is permitted to participate in the metaverse collaborative session (or join or navigate to the metaverse environment). However, the contextual access and navigational information may indicate that the user is not permitted to participate in the metaverse collaborative session based on the contextual information. Therefore, the server device 305 may deny the request based on the contextual access and navigational information indicating that the user is not permitted to participate in the metaverse collaborative session. Additionally, or alternatively, the server device 305 may remove a user (e.g., an avatar of a user) that is currently participating in the metaverse collaborative session if the contextual access and navigational information indicates that the user is not permitted to participate in the metaverse collaborative session. This reduces the likelihood of unauthorized disclosure of sensitive information, maintains confidentiality, and/or ensures that only authorized users have access to the relevant information and discussions taking place during the metaverse collaborative session, among other examples.

In some examples, the server device 305 may provide access to information for the metaverse collaborative session based on the contextual access and navigational information. For example, the server device 305 may determine one or more updated aggregation rules based on the contextual access and navigational information. The server device 305 may collect or obtain data or features for the metaverse collaborative session based on the one or more updated aggregation rules (e.g., in a similar manner as described elsewhere herein, such as in connection with reference number 335 and reference number 340). This may improve the likelihood that data or features (e.g., from one or more other metaverse environments or sessions) is available for use during the metaverse collaborative session based on the context of the metaverse collaborative session. For example, the original one or more aggregation rules for the metaverse environment (e.g., determined by the server device 305 as described in connection with reference number 335) may not make some data available for the metaverse environment. In some examples, based on the context of the metaverse collaborative session, the data may be relevant to a discussion, activity, or function associated with the metaverse collaborative session. The server device 305 may be enabled to determine an updated aggregation rule (e.g., based on the contextual information) that causes the server device 305 to obtain and make the data available in the metaverse environment (e.g., for the metaverse collaborative session). For example, the server device 305 may make the data available in the metaverse environment in real-time based on the context of the metaverse collaborative session (e.g., without receiving an explicit request from a user or system to make the data available in the metaverse environment). This reduces latency and/or conserves resources (e.g., processing resources, network resources, and/or memory resources) that would have otherwise been associated with making the data available in the metaverse environment (e.g., for the metaverse collaborative session).

In some examples, as shown by reference number 380, the server device 305 may update the ontology hierarchy information based on one or more changes to the domain. For example, the server device 305 may dynamically update the ontology hierarchy information based on changes in the domain. The one or more changes in the domain may include one or more changes in the structure of the domain or changes in relationships among the multiple levels of classes. For example, the server device 305 may determine access and navigational information for the metaverse environments associated with the domain using the updated ontology hierarchy information (e.g., in a similar manner as described in more detail elsewhere herein, such as in connection with FIG. 3A and reference numbers 320 through 335). This may improve the likelihood of the server device 305 using navigation and access control mechanisms that are accurate and effective in light of a changing structure or relationship(s) associated with the domain.

For example, the changes in the domain may include modifications to the organizational structure, such as the addition or removal of departments, teams, or roles, which may impact the relationships among the multiple levels of classes. The server device 305 may dynamically update the ontology hierarchy information to reflect such changes, ensuring that the navigation and access control mechanisms are adjusted accordingly. For example, if a new department is added to the organization, the server device 305 may update the ontology hierarchy information to include the new department and its relationships with other departments and teams. The server device 305 may update the ontology hierarchy information based on changes in relationships among the multiple levels of classes, such as changes in reporting structures or collaborations between teams. For example, if a team is reassigned to a different department, the server device 305 may update the ontology hierarchy information to reflect the new relationships between the team and a parent department, as well as relationships with other teams and departments. By dynamically updating the ontology hierarchy information based on changes in the domain, the server device 305 can ensure that the navigation and access control mechanisms remain effective and efficient, even in the face of organizational change.

As indicated above, FIGS. 3A-3C are provided as an example. Other examples may differ from what is described with regard to FIGS. 3A-3C.

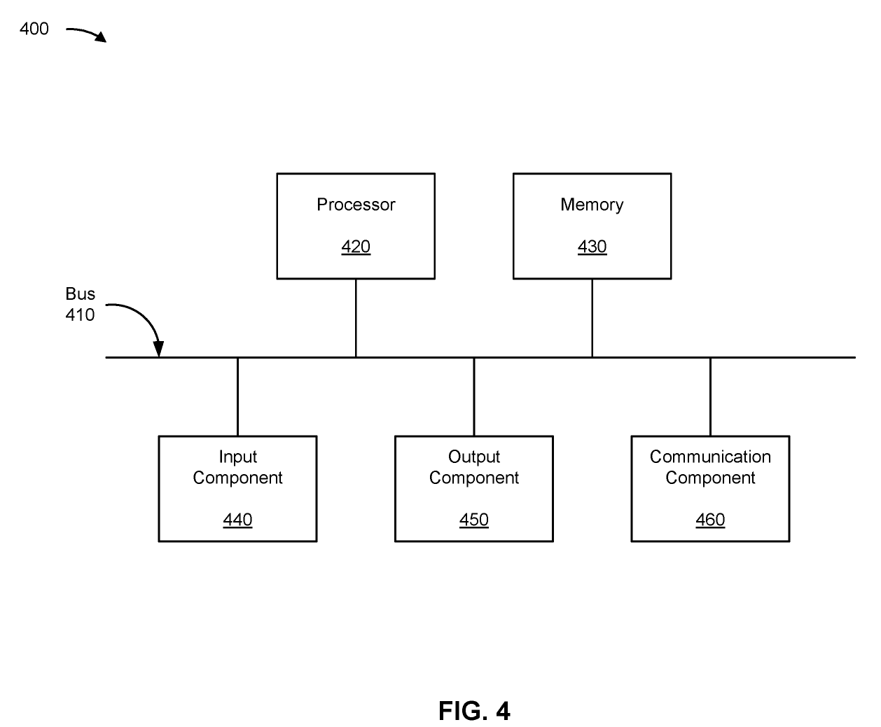

FIG. 4 is a diagram of example components of a device 400 associated with ontology-hierarchy-based metaverse navigation and collaboration. The device 400 corresponds to one or more of the computer 102, a device or component depicted and described in connection with FIG. 1, the server device 305 and/or the client device 310. In some implementations, the computer 102, a device or component depicted and described in connection with FIG. 1, the server device 305, and/or the client device 310 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

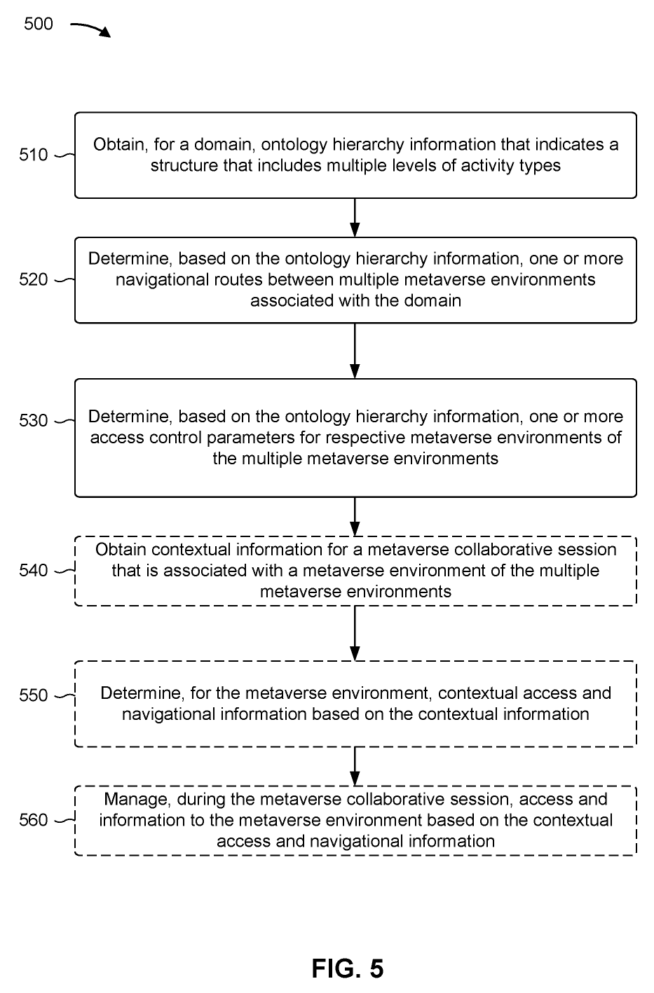

FIG. 5 is a flowchart of an example process 500 associated with ontology-hierarchy-based metaverse navigation and collaboration. One or more process blocks of FIG. 5 are performed by a server device (e.g., the server device 305) and/or by another device or a group of devices separate from or including the server device, such a client device (e.g., the client device 310). Additionally, or alternatively, one or more process blocks of FIG. 5 may be performed by one or more components of device 400, such as processor 420, memory 430, input component 440, output component 450, and/or communication component 460.

As shown in FIG. 5, process 500 includes obtaining, for a domain, ontology hierarchy information that indicates a structure that includes multiple levels of classes (block 510). For example, the server device may obtain, for a domain, ontology hierarchy information that indicates a structure that includes multiple levels of classes, as described above. In some implementations, the ontology hierarchy information indicates one or more relationships among the multiple levels of classes

As further shown in FIG. 5, process 500 includes determining, based on the ontology hierarchy information, one or more navigational routes between multiple metaverse environments associated with the domain (block 520). For example, the server device may determine, based on the ontology hierarchy information, one or more navigational routes between multiple metaverse environments associated with the domain, as described above. In some implementations, the multiple metaverse environments are associated with respective classes.

As further shown in FIG. 5, process 500 includes determining, based on the ontology hierarchy information, one or more access control parameters for respective metaverse environments of the multiple metaverse environments (block 530). For example, the server device may determine, based on the ontology hierarchy information, one or more access control parameters for respective metaverse environments of the multiple metaverse environments, as described above. In some implementations, the one or more access control parameters indicate one or more permissible users and/or permissible information types for the respective metaverse environments.

As further shown in FIG. 5, process 500 optionally includes obtaining contextual information for a metaverse collaborative session that is associated with a metaverse environment of the multiple metaverse environments (block 540). For example, the server device may obtain contextual information for a metaverse collaborative session that is associated with a metaverse environment of the multiple metaverse environments, as described above.

As further shown in FIG. 5, process 500 optionally includes determining, for the metaverse environment, contextual access and navigational information based on the contextual information (block 550). For example, the server device may determine, for the metaverse environment, contextual access and navigational information based on the contextual information, as described above. In some implementations, the contextual access and navigational information indicates at least one of one or more updated access control parameters, or one or more updated navigational routes.

As further shown in FIG. 5, process 500 optionally includes managing, during the metaverse collaborative session, access and information to the metaverse environment based on the contextual access and navigational information (block 560). For example, the server device may manage, during the metaverse collaborative session, access and information to the metaverse environment based on the contextual access and navigational information, as described above.

Process 500 may include additional aspects, such as any single aspect or any combination of aspects described below and/or in connection with one or more other processes described elsewhere herein.

In a first aspect, the metaverse collaborative session is associated with a first level of class from the multiple levels of classes, where the multiple levels of classes are associated with respective sets of one or more aggregation rules that are based on the ontology hierarchy information, and process 500 includes identifying, based on a set of one or more aggregation rules, one or more metaverse collaborative sessions associated with one or more second levels of class, where the set of one or more aggregation rules is associated with the first level of class, obtaining session information for the metaverse collaborative session from the one or more metaverse collaborative sessions, and providing the session information to be available during the metaverse collaborative session.

In a second aspect, alone or in combination with the first aspect, the first level of class is a parent level and the one or more second levels of class are child levels with respect to the first level as indicated by the ontology hierarchy information.

In a third aspect, alone or in combination with one or more of the first and second aspects, process 500 includes receiving a request for a user to participate in the metaverse collaborative session, where the one or more access control parameters indicate that the user is permitted to participate in the metaverse collaborative session, and where the contextual access and navigational information indicate that the user is not permitted to participate in the metaverse collaborative session based on the contextual information, and denying the request based on the contextual access and navigational information indicating that the user is not permitted to participate in the metaverse collaborative session.

In a fourth aspect, alone or in combination with one or more of the first through third aspects, process 500 includes updating the ontology hierarchy information based on one or more changes to the domain.

In a fifth aspect, alone or in combination with one or more of the first through fourth aspects, the one or more changes in the domain include changes in the structure of the domain or changes in relationships among the multiple levels of classes.

In a sixth aspect, alone or in combination with one or more of the first through fifth aspects, the metaverse collaborative session is associated with a first level of class from the multiple levels of classes, and process 500 includes updating, based on the contextual information, the metaverse collaborative session to be associated with a second level of class from the multiple levels of classes.

In a seventh aspect, alone or in combination with one or more of the first through sixth aspects, the one or more relationships among the multiple levels of classes include at least one of hierarchical relationships, peer-to-peer relationships, or role-based relationships.

In an eighth aspect, alone or in combination with one or more of the first through seventh aspects, the one or more access control parameters include at least one of role-based access control, attribute-based access control, or policy-based access control.

In a ninth aspect, alone or in combination with one or more of the first through eighth aspects, the contextual information for the metaverse collaborative session includes at least one of sentiment analysis information, participant information, topic information, or agenda information.

In a tenth aspect, alone or in combination with one or more of the first through ninth aspects, the contextual access and navigational information indicates at least one of updated permissible users, updated permissible information types, or updated navigational routes.

In an eleventh aspect, alone or in combination with one or more of the first through tenth aspects, the managing of access and information to the metaverse environment includes at least one of granting access to the metaverse collaborative session, denying access to the metaverse collaborative session, or providing access to information for the metaverse collaborative session.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, for a domain, ontology hierarchy information that indicates a structure that includes multiple levels of classes, wherein the ontology hierarchy information indicates one or more relationships among the multiple levels of classes;
determining, based on the ontology hierarchy information, one or more navigational routes between multiple metaverse environments associated with the domain, wherein the multiple metaverse environments are associated with respective classes;
determining, based on the ontology hierarchy information, one or more access control parameters for respective metaverse environments of the multiple metaverse environments, wherein the one or more access control parameters indicate one or more permissible users or permissible information types for the respective metaverse environments;
obtaining contextual information for a metaverse collaborative session that is associated with a metaverse environment of the multiple metaverse environments;
determining, for the metaverse environment, contextual access and navigational information based on the contextual information, wherein the contextual access and navigational information indicates at least one of one or more updated access control parameters, or one or more updated navigational routes; and
managing, during the metaverse collaborative session, access and information to the metaverse environment based on the contextual access and navigational information.

2. The method of claim 1, wherein the metaverse collaborative session is associated with a first level of class from the multiple levels of classes, wherein the multiple levels of classes are associated with respective sets of one or more aggregation rules that are based on the ontology hierarchy information, and the method further comprising:
identifying, based on a set of one or more aggregation rules, one or more metaverse collaborative sessions associated with one or more second levels of class, wherein the set of one or more aggregation rules is associated with the first level of class;
obtaining session information for the metaverse collaborative session from the one or more metaverse collaborative sessions; and
providing the session information to be available during the metaverse collaborative session.

3. The method of claim 2, wherein the first level of class is a parent level and the one or more second levels of class are child levels with respect to the first level as indicated by the ontology hierarchy information.

4. The method of claim 1, further comprising:
receiving a request for a user to participate in the metaverse collaborative session, wherein the one or more access control parameters indicate that the user is permitted to participate in the metaverse collaborative session, and wherein the contextual access and navigational information indicate that the user is not permitted to participate in the metaverse collaborative session based on the contextual information; and
denying the request based on the contextual access and navigational information indicating that the user is not permitted to participate in the metaverse collaborative session.

5. The method of claim 1, further comprising:
updating the ontology hierarchy information based on one or more changes to the domain.

6. The method of claim 5, wherein the one or more changes in the domain comprise changes in the structure of the domain or changes in relationships among the multiple levels of classes.

7. The method of claim 1, wherein the metaverse collaborative session is associated with a first level of class from the multiple levels of classes, and the method further comprising:
update, based on the contextual information, the metaverse collaborative session to be associated with a second level of class from the multiple levels of classes.

8. The method of claim 1, wherein the one or more relationships among the multiple levels of classes comprise at least one of hierarchical relationships, peer-to-peer relationships, or role-based relationships.

9. The method of claim 1, wherein the one or more access control parameters comprise at least one of role-based access control, attribute-based access control, or policy-based access control.

10. The method of claim 1, wherein the contextual information for the metaverse collaborative session comprises at least one of:
sentiment analysis information,
participant information,
topic information, or
agenda information.

11. The method of claim 1, wherein the contextual access and navigational information indicates at least one of updated permissible users, updated permissible information types, or updated navigational routes.

12. The method of claim 1, wherein the managing of access and information to the metaverse environment comprises at least one of:
granting access to the metaverse collaborative session,
denying access to the metaverse collaborative session, or
providing access to information for the metaverse collaborative session.

13. A computer system comprising:
a processor set;
one or more computer readable storage media; and
program instructions stored on the one or more computer readable storage media to cause the processor set to perform operations comprising:
obtaining, for a domain, ontology hierarchy information that indicates a structure that includes multiple levels of classes,
wherein the ontology hierarchy information indicates one or more relationships among the multiple levels of classes;
determining, based on the ontology hierarchy information, one or more navigational routes between multiple metaverse environments associated with the domain;
managing access to a first metaverse environment, of the multiple metaverse environments, based on a user role and the ontology hierarchy information; and
updating the one or more navigational routes and access to the first metaverse environment based on one or more changes in the ontology hierarchy information.

14. The computer system of claim 13, wherein the operations comprise:
executing one or more aggregation rules to collect information from a second metaverse environments; and
provide the information to the first metaverse environment, wherein the one or more aggregation rules are based on the ontology hierarchy information.

15. The computer system of claim 13, wherein the operations comprise:
obtaining contextual information for a metaverse collaborative session associated with the first metaverse environment; and
determine updated access and navigational information for the first metaverse environment based on the contextual information.

16. The computer system of claim 13, wherein the one or more navigational routes indicate permissible routes for users based on the user role and the ontology hierarchy information.

17. The computer system of claim 13, wherein the managing of access to the first metaverse environment comprises at least one of:
granting access to the first metaverse environment,
denying access to the first metaverse environment, or
providing access to information for the first metaverse environment.

18. A computer program product comprising:
one or more computer readable storage media; and
program instructions stored on the one or more computer readable storage media to perform operations comprising:
obtaining, for a domain, ontology hierarchy information that indicates a structure that includes multiple levels of classes,
wherein the ontology hierarchy information indicates one or more relationships among the multiple levels of classes;
determining, based on the ontology hierarchy information, one or more navigational routes between multiple metaverse environments associated with the domain,
wherein the multiple metaverse environments are associated with respective classes;
determining, based on the ontology hierarchy information, one or more access control parameters for respective metaverse environments of the multiple metaverse environments,
wherein the one or more access control parameters indicate one or more permissible users or permissible information types for the respective metaverse environments;
obtaining contextual information for a metaverse collaborative session that is associated with a metaverse environment of the multiple metaverse environments;
determining, for the metaverse environment, contextual access and navigational information based on the contextual information,
wherein the contextual access and navigational information indicates at least one of one or more updated access control parameters, or one or more updated navigational routes; and
managing, during the metaverse collaborative session, access and information to the metaverse environment based on the contextual access and navigational information.

19. The computer program product of claim 18, further comprising:
dynamically updating the ontology hierarchy information based on changes in the domain.

20. The computer program product of claim 18, wherein the one or more relationships among the multiple levels of classes comprise at least one of hierarchical relationships, peer-to-peer relationships, or role-based relationships.
